(19) United States
(12) Patent Application Publication
(10) Pub. No.: US 2015/0074474 A1
(43) Pub. Date: Mar. 12, 2015

(54) SYSTEM AND METHOD FOR ON-THE-FLY INCREMENTAL MEMORY REPAIR

(71) Applicant: BROADCOM CORPORATION, Irvine, CA (US)

(72) Inventors: Mohammad Issa, Los Altos, CA (US); Rakesh Kumar Kinger, Fremont, CA (US)

(73) Assignee: BROADCOM CORPORATION, Irvine, CA (US)

(21) Appl. No.: 14/040,374

(22) Filed: Sep. 27, 2013

Related U.S. Application Data
(60) Provisional application No. 61/874,922, filed on Sep. 6, 2013.

(51) Int. Cl. G06F 11/20

(52) U.S. Cl. CPC G06F 11/2094
USPC 714/710

(57) ABSTRACT

A device for repairing a memory device may include spare memory blocks that may replace corresponding memory blocks that include at least one non-operational memory cell. One or more registers may be coupled in a chain to store memory repair information. A memory repair module may identify, upon a power-up test of the memory device, non-operational memory cells, which are incremental to previously identified defective memory cells in previous power-up tests, and may provide corresponding memory repair information of the identified non-operational memory cells. A logic circuit may block access to one or more registers and may facilitate storing, in one or more unblocked registers, the corresponding memory repair information of the identified one or more non-operational memory cells. The memory repair module may swap a memory block including the identified non-operational memory cells with a spare memory block based on content of the one or more unblocked registers.

### CROSS-REFERENCE TO RELATED APPLICATIONS

This application claims the benefit of priority under 35 U.S.C. §119 from U.S. Provisional Patent Application 61/874,922 filed Sep. 6, 2013, which is incorporated herein by reference in its entirety.

### TECHNICAL FIELD

The present description relates generally to memory systems, and more particularly, but not exclusively, to system and method for on-the-fly incremental memory repair.

### BACKGROUND

Many memory devices such as mass storage memory devices may include a large number of memory cells, one or more of which may be initially defective due to non-ideal manufacturing processes, or may become defective during application due to degradation and wear out. The initial defective memory cells or blocks may be identified by the manufacturer and provided through the data sheet of the memory device. Many systems may keep track of bad memory cells or blocks during the life of the memory device and store a list of defective one or more faulty addresses associated with one or more bad memory cells or blocks.

Memory devices may include embedded built-in-self-test (BIST) engines that can facilitate testing of each memory device. In addition, built-in-self-repair (BISR) chains can be used to repair one or more bad memory cells. The BISR chain may be formed by serially connecting sequential elements in a scan chain fashion so that the required data can be shifted into sequential elements.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example of a device for on-the-fly incremental memory repair, in accordance with one or more implementations.

FIG. 2A illustrates examples of a register block and a logic circuit of the device of FIG. 1, in accordance with one or more implementations.

FIG. 2B illustrates an example of a register segment of the register block of FIG. 2A, in accordance with one or more implementations.

FIG. 2C illustrates an example of built-in-self-repair (BISR) segments driving memory repair of memory row banks, in accordance with one or more implementations.

FIG. 2D illustrates an example of a memory including spare blocks for on-the-fly incremental memory repair, in accordance with one or more implementations.

FIG. 3 illustrates an example of a system for on-the-fly incremental memory repair, in accordance with one or more implementations.

FIG. 4 illustrates an example of a method for on-the-fly incremental memory repair, in accordance with one or more implementations.

FIG. 5 illustrates an example of a communication device using a device for on-the-fly incremental memory repair, in accordance with one or more implementations.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced using one or more implementations. In one or more instances, well-known structures and components are shown in block diagram form in order to avoid obscuring the concepts of the subject technology.

The subject technology is directed to a method and implementation for on-the-fly incremental repair of a memory device. The disclosed solution can be built on the existing hardware infrastructure (e.g., built-in-self-repair (BISR) registers) that can be leveraged to enable memory repair. The BISR registers content may drive the memory repair inputs, based on which the faulty row or column or both can be swapped with spare row and column resources available inside the memory device, thus making the memory device defect-free and operational. The memory repair may be an incremental repair performed in the event any error in the memory device is detected later in the field during the normal functional mode of operation of the memory device. The subject on-the-fly incremental repair may be performed while the system is operational without impacting the mission mode.

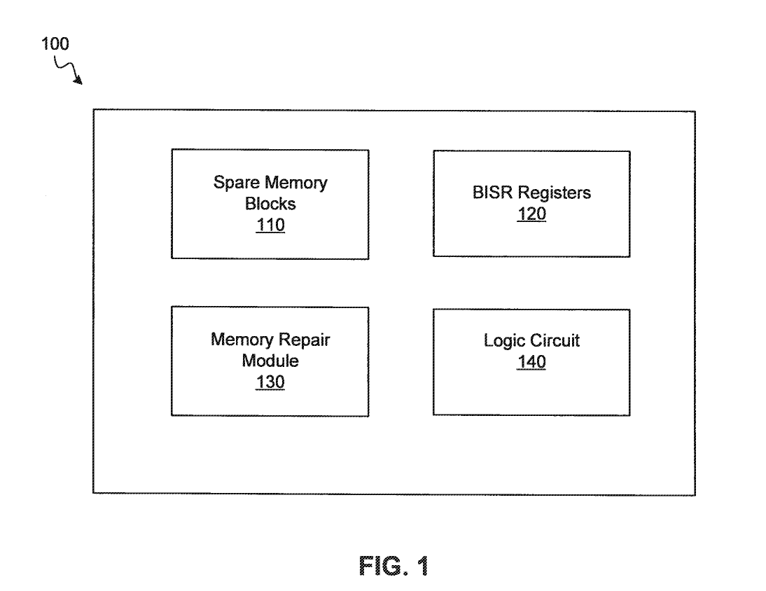

FIG. 1 illustrates an example of a device 100 for on-the-fly incremental memory repair, in accordance with one or more implementations of the subject technology. The device 100 may be integrated with a memory device of a system and may provide for on-the-fly repair of the memory device. During a boot-up of the system, a memory sanity check may be performed to identify defective memory cells or blocks of the memory device, which can be repaired by the device 100. The device 100 may include spare memory blocks 110, registers 120 (e.g., BISR registers already existing in the memory device), a memory repair module 130, and a logic circuit 140. The spare memory blocks 110 may be present in the memory device and may be used to replace corresponding memory blocks that include one or more non-operational memory cells. Registers 120 may include a number of registers that may be coupled in a chain to store memory repair information such as address information. Upon the upon a power-up test of the memory device, the memory repair module 130 may identify non-operational memory cells, which can be incremental to previously identified defective memory cells in previous power-up tests.

The memory repair module 130 may provide corresponding memory repair information (e.g., such as address information) of the identified non-operational memory cells. The logic circuit 140 may block access to one or more registers that contain non-zero content, and may facilitate storing, in one or more unblocked registers, the corresponding memory repair information of the non-operational memory cell(s). The memory repair module 130 may swap a memory block including the identified non-operational memory cells with a spare memory block based on content of the unblocked registers, which may include addresses of replacement spare blocks for the identified non-operational memory cells, as described in more detail herein. The memory repair module 130 may facilitate repairing of the memory device on-the fly and while the memory device is in a normal mode of operation. In one or more embodiments, the memory repair module 130 may be implemented in software.

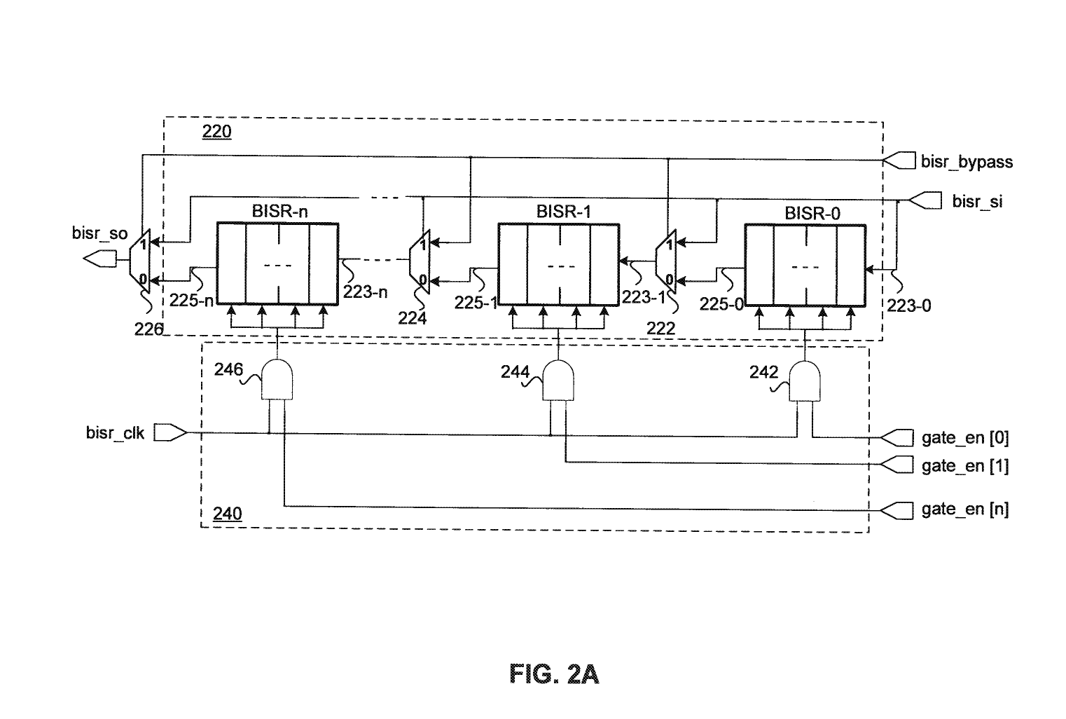

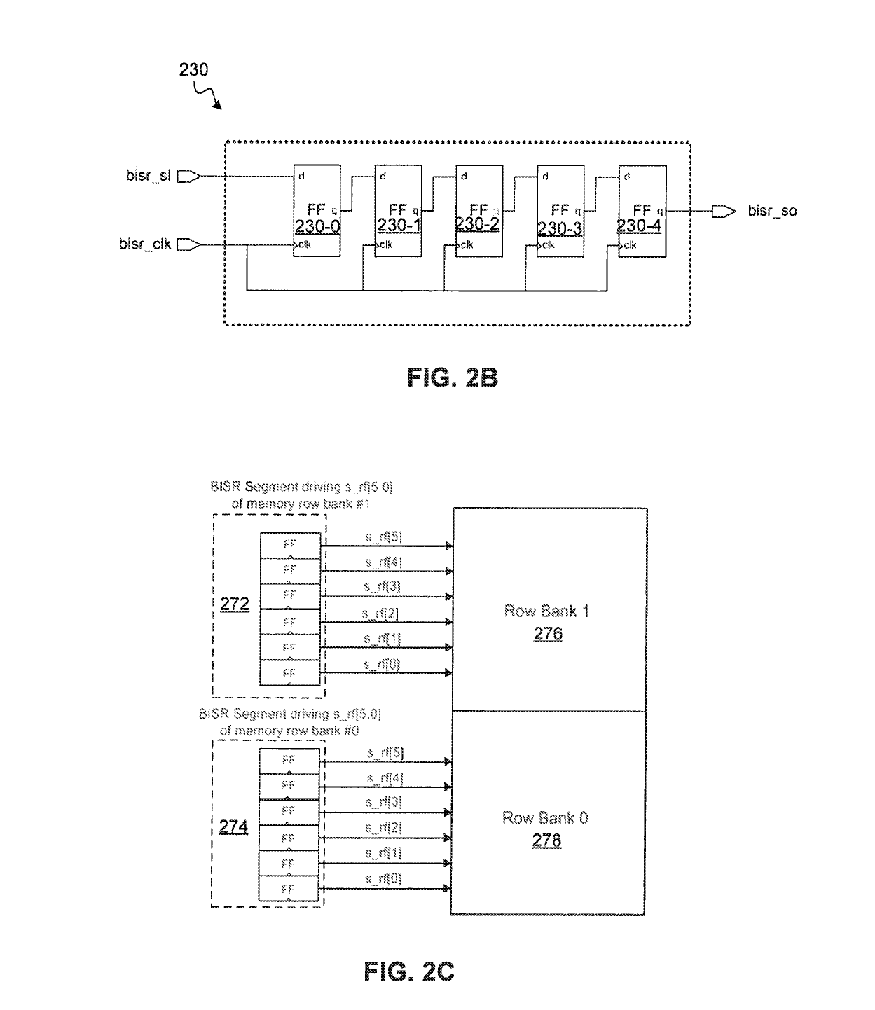

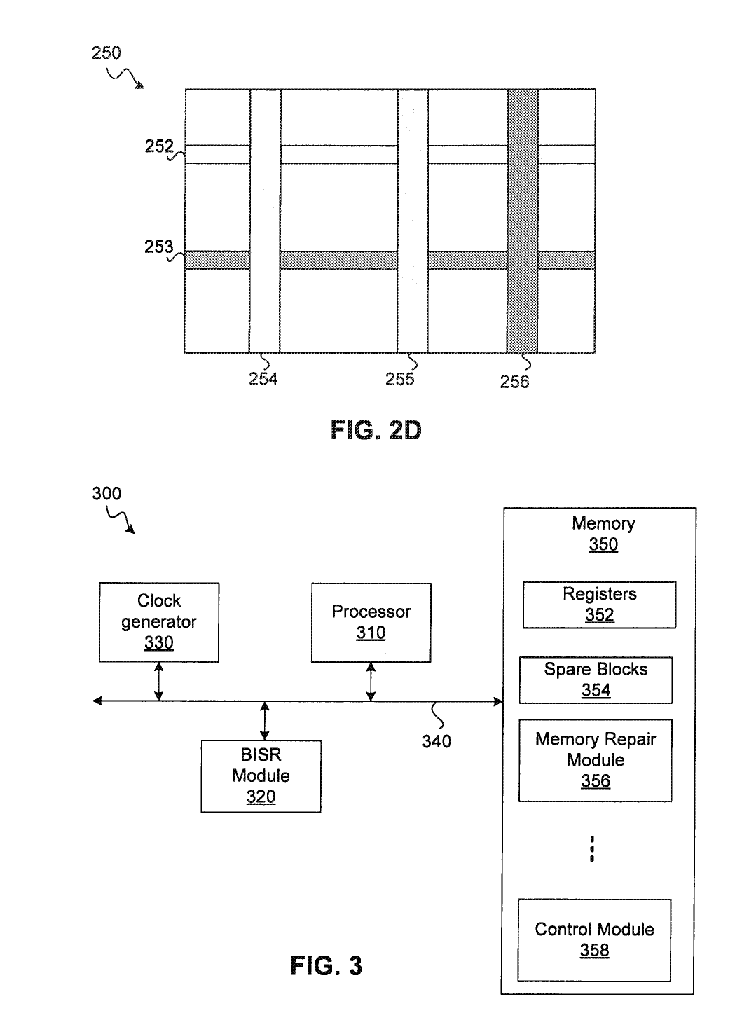

FIG. 2A illustrates examples of a register block 220 and a logic circuit 240 of the device 100 of FIG. 1, in accordance with one or more implementations of the subject technology. The register block 220 is an example of the BISR registers 120 of FIG. 1 and may include a number of BISR register segments (e.g., BISR-0, BISR-1 BISR-n) coupled in a chain and a number of multiplexers (e.g., 222, 224 . . . 226). The scan output (e.g., one of 225-0, 225-1 . . . 225-n) of each BISR register segment is coupled to a scan input (e.g., one of 223-0, 223-1 . . . 223-n) of the following BISR register segment. Each BISR register segments can retain a number of bits (e.g., 4 bits) that may represent an address corresponding to a memory block (e.g., a spare memory block) of the memory device. The address of the spare memory block may be used instead of an address of a memory block that is identified as being defective, Since some of the spare memory blocks (e.g., 110 of FIG. 1) may have been already utilized for the previously identified defective memory blocks (e.g., row or columns including at least one bad memory cell), the addresses corresponding to the utilized spare blocks may already exist in some of the register segments of the register block 220. In order to keep these already used register segments intact, these segments are blocked from being changed by the logic circuit 240.

In the absence of the multiplexers 222, 224 . . . 226, and the logic circuit 240, a bit entered at the scan input 233-0 (e.g., a bistr_si input) could be shifted through the BISR register segments at an edge of a clock signal (e.g., at a bisr_clk). The logic circuit 240 may use AND gates 242, 244 . . . 246 to block one or more BISR register segments by disabling their corresponding clock signal. In some aspects, for each BISR register segment (e.g., BISR-1), there is a gate-enable signal (e.g., gate_en[1]) on a gate_en[n:0]) control bus that can enable/disable the clock signal for that BISR register segment. For example, when gate_en[1] is set to zero, the AND gate 244 disallows the clock signal at bisr_clk to reach the BISR register segment BISR-1. Therefore, a bit present at the scan input 223-1 cannot be clocked into the BISR register segment BISR-1. The multiplexers 222, 224 . . . 226 allow bypassing of a blocked BISR register segment from the chain of BISR register segments based on a bisr_bypass control signal. In the normal mode of operation, a bisr_bypass can be asserted low so that a scan input can be shifted through the BISR register segments. When a new content is to be shifted via the bisr_si input into BISR registers, bisr_bypass control signal can be asserted high (e.g., by the memory repair module 130 of FIG. 1). For the BISR registers segment(s) that the new shifted data needs to take into effect, corresponding bit(s) of gate_en[n:0] control bus is asserted high to enable the clock gate so that the new value can be clocked in. For the remaining BISR segments that the previous contents is to be preserved, the memory repair module 130 may assert the corresponding bit(s) of the gate_en[n:0] control bus low to shut off the clock signal and hence prevent the new data to be clocked in. The disclosed technique allows on-the-fly repair of the affected memories and ensures minimal disruption to the system operation. The incremental repair information that is shifted in the BISR register segments is then merged with the previous BISR contents shifted during previous power-ups and the new updated repair data is programmed in a storage media so that the updated data can be shifted in during the next power up cycle and all the memories are successfully repaired.

FIG. 2B illustrates an example of a register segment 230 of the register block 220 of FIG. 2A, in accordance with one or more implementations of the subject technology. The register segment 230 includes a chain of sequential elements (e.g., flip-flops such as FF 230-0 to FF 230-4). Each element is connected to a clock signal (e.g., bisr_clk). The scan input bisr_si can be shifted through the elements at the suitable edges of the clock signal. For example, the bisr-si input can reach a q output of the FF 230-4 (e.g., as a scan output signal bisr-so) after four clock signals.

FIG. 2C illustrates an example of built-in-self-repair (BISR) segments 272 and 274 driving memory repair of memory row banks 276 and 278 of a memory, in accordance with one or more implementations of the subject technology. The BISR segments 272 and 274 each includes a number of (e.g., six) flip-flops. Each flip-flop can drive a number of (e.g., six) memory control inputs (e.g., s_rf[5:0]). The values on these control inputs may be decoded inside the memory to decide which of the defective memory rows or columns or both has to be swapped with unused spare blocks. Each of the row banks 276 and 278 may be driven by a separate BISR segments (e.g., 272 and 274), thus providing individual access to memory row bank 276 and 278 for repair.

FIG. 2D illustrates an example of a memory device 250 including spare blocks for on-the-fly incremental memory repair, in accordance with one or more implementations of the subject technology. The memory device 250 may be an embedded memory, which may be present in many on-chip systems. The memory device 250 may include a number of spare blocks, such as spare rows (e.g., 252 and 253) and spare columns 254, 255, and 256. Some of the spare blocks (e.g., 253 and 256) may have been already used to replace defective memory blocks identified in previous power-up operations. The address of these blocks (e.g., previously used blocks) may exist in the register block 220 of FIG. 2A. The addresses of the unused spare blocks (e.g., 252, 254, and 255) can be shifted into the register segments of the register block 220 of FIG. 2A, as described above, to replace addresses of the identified non-operational memory blocks.

FIG. 3 illustrates an example of a system 300 for on-the-fly incremental memory repair, in accordance with one or more implementations of the subject technology. The system 300 may include a processor 310, a BISR module 320, a clock generator 330, and memory 350, coupled to one another via a bus 340. Examples of the processor 310 may include a general-purpose processor, a core processor, a multi-core processor, or other types of processors. The clock generator 330 may be responsible for generating clock signals (e.g., bisr_clk of FIG. 2A). Examples of the memory 350 may include RAM, DRAM, static RAM (SRAM), flash memory, or other types of memory. The BISR modules 320 may include the already existing BISR, which may include a built-in-self-test (BIST) component that can test a memory device to determine faulty memory cells or blocks.

In some aspects, the memory 350 may include a number of registers 352 (e.g., BISR registers), spare blocks 354, and a number of program modules that can be executed by the processor 310. The spare blocks may include spare rows and columns reserved to replace faulty memory blocks. The program modules may include a memory repair module 356, and a control module 358. In some implementations, the memory repair module 356 when executed by a processor (e.g., processor 310) may perform the functionalities of the memory repair module 130 described above with respect to FIG. 1. In some aspects, the control module 358, when executed by a processor (e.g., processor 310), may perform the functionalities of the logic circuit 240 of FIG. 2A, may set the bit(s) of gate_en[n:0] control bus of FIG. 2A, and may generate the bisr_bypass signal of FIG. 2A.

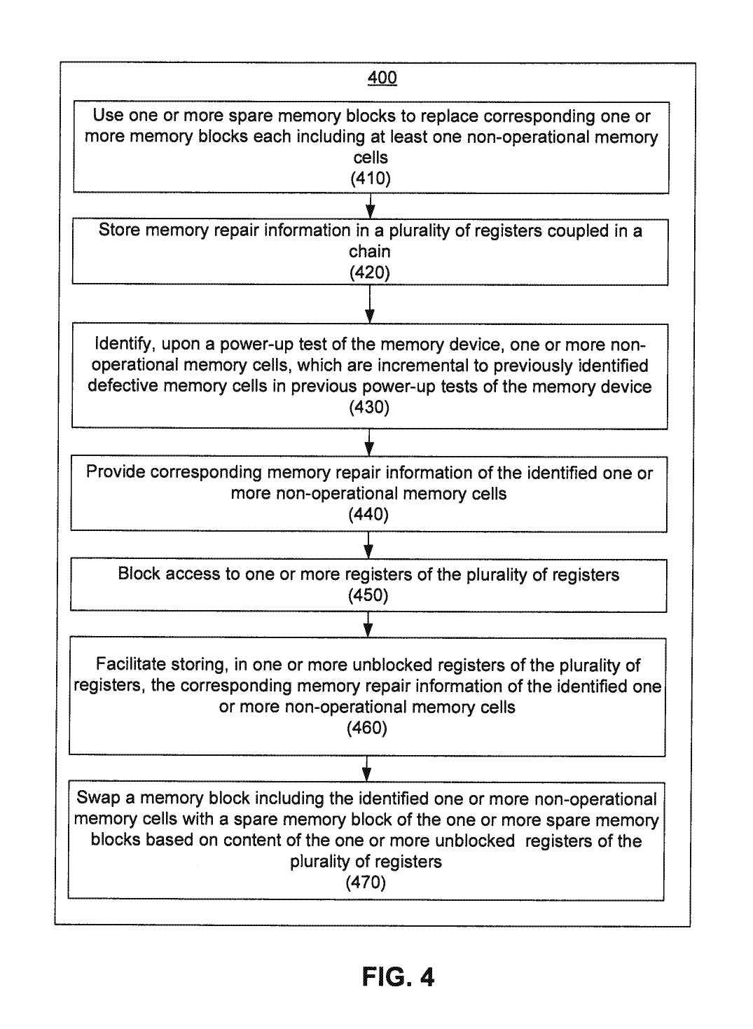

FIG. 4 illustrates an example of a method 400 for on-the-fly incremental memory repair, in accordance with one or more implementations. The steps of the method 400 do not need to be performed in the order shown and one or more steps may be omitted. One or more spare memory blocks (e.g., 252-256 of FIG. 2D) may be used (e.g., by 130 of FIG. 1 or 356 of FIG. 3) to replace corresponding one or more memory blocks each including at least one non-operational memory cells (410). Memory repair information may be stored in a number of registers (e.g., BISR-0 to BISR-n of FIG. 2A) coupled in a chain (420). Upon a power-up test (e.g., by BIST of 320 of FIG. 3) of the memory device (e.g., 100 of FIG. 1), one or more non-operational memory cells, which are incremental to previously identified defective memory cells in previous power-up tests of the memory device may be identified (430). Corresponding memory repair information of the identified one or more non-operational memory cells may be provided (e.g., by 130 of FIG. 1 or 356 of FIG. 3) (440). Access to one or more registers of the plurality of registers may be blocked (e.g., by 240 of FIG. 2A) (450). Repair information of the identified one or more non-operational memory cells may be Stored (e.g., by 130 of FIG. 1 or 356 of FIG. 3), in one or more unblocked registers of the plurality of registers the corresponding memory (460). A memory block including the identified non-operational memory cells may be swapped (e.g., by 130 of FIG. 1 or 356 of FIG. 3) with the spare memory blocks based on content of the unblocked registers of the plurality of registers (470).

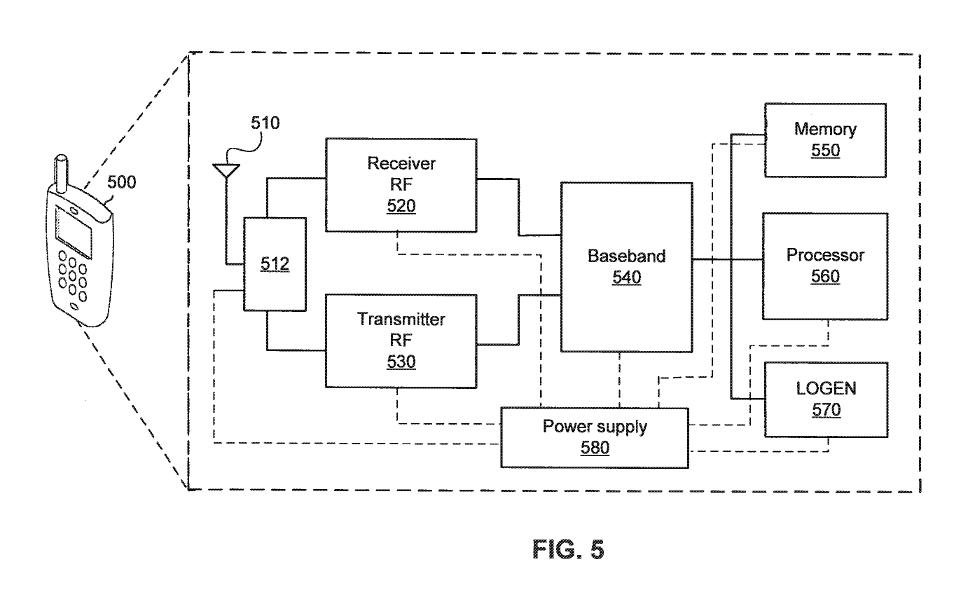

FIG. 5 illustrates an example of a wireless communication device using a device for on-the-fly incremental memory repair, in accordance with one or more implementations of the subject technology. The wireless communication device 500 may comprise a radio-frequency (RF) antenna 510, a receiver 520, a transmitter 530, a baseband processing module 540, a memory 550, a processor 560, a local oscillator generator (LOGEN) 570, and a power supply 580. In various embodiments of the subject technology, one or more of the blocks represented in FIG. 5 may be integrated on one or more semiconductor substrates. For example, the blocks 520-470 may be realized in a single chip or a single system on chip, or may be realized in a multi-chip chipset.

The RF antenna 510 may be suitable for transmitting and/or receiving RF signals (e.g., wireless signals) over a wide range of frequencies. Although a single RF antenna 510 is illustrated, the subject technology is not so limited.

The receiver 520 may comprise suitable logic circuitry and/or code that may be operable to receive and process signals from the RF antenna 510. The receiver 520 may, for example, be operable to amplify and/or down-covert received wireless signals. In various embodiments of the subject technology, the receiver 520 may be operable to cancel noise in received signals and may be linear over a wide range of frequencies. In this manner, the receiver 520 may be suitable for receiving signals in accordance with a variety of wireless standards. Wi-Fi, WiMAX, Bluetooth, and various cellular standards.

The transmitter 530 may comprise suitable logic circuitry and/or code that may be operable to process and transmit signals from the RF antenna 510. The transmitter 530 may, for example, be operable to up-covert baseband signals to RF signals and amplify RF signals. In various embodiments of the subject technology, the transmitter 530 may be operable to up-convert and amplify baseband signals processed in accordance with a variety of wireless standards. Examples of such standards may include Wi-Fi, WiMAX, Bluetooth, and various cellular standards. In various embodiments of the subject technology, the transmitter 530 may be operable to provide signals for further amplification by one or more power amplifiers.

The duplexer 512 may provide isolation in the transmit band to avoid saturation of the receiver 520 or damaging parts of the receiver 520, and to relax one or more design requirements of the receiver 520. Furthermore, the duplexer 512 may attenuate the noise in the receive band. The duplexer may be operable in multiple frequency bands of various wireless standards.

The baseband processing module 540 may comprise suitable logic, circuitry, interfaces, and/or code that may be operable to perform processing of baseband signals. The baseband processing module 540 may, for example, analyze received signals and generate control and/or feedback signals for configuring various components of the wireless communication device 500 such as the receiver 520. The baseband processing module 540 may be operable to encode, decode, transcode, modulate, demodulate, encrypt, decrypt, scramble, descramble, and/or otherwise process data in accordance with one or more wireless standards.

The processor 560 may comprise suitable logic, circuitry, and/or code that may enable processing data and/or controlling operations of the wireless communication device 500. In this regard, the processor 560 may be enabled to provide control signals to various other portions of the wireless communication device 500. The processor 560 may also control transfers of data between various portions of the wireless communication device 500. Additionally, the processor 560 may enable implementation of an operating system or otherwise execute code to manage operations of the wireless communication device 500.

The memory 550 may comprise suitable logic, circuitry, and/or code that may enable storage of various types of information such as received data, generated data, code, and/or configuration information. The memory 550 may comprise, for example, RAM, ROM, flash, and/or magnetic storage. In various embodiment of the subject technology, Information stored in the memory 550 may be utilized for configuring the receiver 520 and/or the baseband processing module 540.

In one or more implementations, the memory 550 may also include a number of registers (e.g., 120 of FIG. 1 or 352 of FIG. 3) such as BISR registers, spare memory blocks (e.g., 110 of FIG. 1, or 354 of FIG. 3), a memory repair module (e.g., 130 of FIG. 1 or 356 of FIG. 3), a logic circuit (e.g., 140 of FIG. 1 or 240 of FIG. 2A), which can perform on-the-fly incremental memory repair, as discussed above.

The local oscillator generator (LOG EN) 570 may comprise suitable logic, circuitry, interfaces, and/or code that may be operable to generate one or more oscillating signals of one or more frequencies. The LOGEN 570 may be operable to generate digital and/or analog signals. In this manner, the LOGEN 570 may be operable to generate one or more clock signals and/or sinusoidal signals. Characteristics of the oscillating signals such as the frequency and duty cycle may be determined based on one or more control signals from, for example, the processor 560 and/or the baseband processing module 540. In operation, the processor 560 may configure the various components of the wireless communication device 500 based on a wireless standard according to which it is desired to receive signals. Wireless signals may be received via the RF antenna 510 and amplified and down-converted by the receiver 520. The baseband processing module 540 may perform noise estimation and/or noise cancellation, decoding, and/or demodulation of the baseband signals. In this manner, information in the received signal may be recovered and utilized appropriately. For example, the information may be audio and/or video to be presented to a user of the wireless communication device, data to be stored to the memory 550, and/or information affecting and/or enabling operation of the wireless communication device 500. The baseband processing module 540 may modulate, encode and perform other processing on audio, video, and/or control signals to be transmitted by the transmitter 530 in accordance to various wireless standards. The power supply 580 may provide one or more regulated rail voltages (e.g., V_{DD}) for various circuitries of the wireless communication device 500.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In some implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

Those of skill in the art would appreciate that the various illustrative blocks, modules, elements, components, and methods described herein may be implemented as electronic hardware, computer software, or combinations of both. To illustrate this interchangeability of hardware and software, various illustrative blocks, modules, elements, components, and methods have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A device for repairing a memory device, the device comprising:
one or more spare memory blocks configured to replace corresponding one or more memory blocks, each of the one or more memory blocks including at least one non-operational memory cell;
a plurality of registers coupled in a chain and configured to store memory repair information;
a memory repair module configured to identify, upon a power-up test of the memory device, one or more non-operational memory cells, which are incremental to previously identified defective memory cells in previous power-up tests of the memory device, and to provide corresponding memory repair information of the identified one or more non-operational memory cells; and
a logic circuit configured to block access to one or more registers of the plurality of registers, and to facilitate storing, in one or more unblocked registers of the plurality of registers, the corresponding memory repair information of the identified one or more non-operational memory cells,
wherein the memory repair module is configured to swap a memory block including the identified one or more non-operational memory cells with a spare memory block of the one or more spare memory blocks based on content of the one or more unblocked registers of the plurality of registers.

2. The device of claim 1, wherein the one or more spare memory blocks comprise at least one of a spare memory row or a spare memory column.

3. The device of claim 1, wherein the plurality of registers comprises already existing built-in-self-repair (BISR) registers.

4. The device of claim 1, wherein each register of the plurality of registers is associated with a memory block, and wherein the content of the one or more unblocked registers of the plurality of registers comprise addresses of spare memory blocks available for incremental repair.

5. The device of claim 1, wherein the memory repair information comprises address information corresponding to non-operational memory cells.

6. The device of claim 1, wherein the logic circuit is configured to block access to the one or more registers of the plurality of registers if content of one or more registers of the plurality of registers is non-zero, indicating that a corresponding spare block of an associated memory block is unavailable.

7. The device of claim 1, wherein the memory repair module is configured to repair the memory device on-the fly while the memory device is in a normal mode of operation.

8. A method for repairing a memory device, the method comprising:
using one or more spare memory blocks to replace corresponding one or more memory blocks each including at least one non-operational memory cell;
storing memory repair information in a plurality of registers coupled in a chain;
identifying, upon a power-up test of the memory device, one or more non-operational memory cells, which are incremental to previously identified defective memory cells in previous power-up tests of the memory device;
providing corresponding memory repair information of the identified one or more non-operational memory cells;
blocking access to one or more registers of the plurality of registers;
facilitating storing, in one or more unblocked registers of the plurality of registers, the corresponding memory repair information of the identified one or more non-operational memory cells; and
swapping a memory block including the identified one or more non-operational memory cells with a spare memory block of the one or more spare memory blocks based on content of the one or more unblocked registers of the plurality of registers.

9. The method of claim 8, wherein using the one or more spare memory blocks comprises using at least one of a spare memory row or a spare memory column.

10. The method of claim 8, wherein storing the memory repair information in the plurality of registers comprises storing the memory repair information in already existing BISR registers.

11. The method of claim 8, wherein each register of the plurality of registers is associated with a memory block, and wherein the content of the one or more unblocked registers of the plurality of registers comprise addresses of spare memory blocks available for incremental repair.

12. The method of claim 8, wherein providing the corresponding memory repair information comprises providing address information corresponding to the non-operational memory cells.

13. The method of claim 8, wherein blocking access to the one or more registers of the plurality of registers is performed if content of one or more registers of the plurality of registers is non-zero, indicating that a corresponding spare block of an associated memory block is unavailable.

14. The method of claim 8, further comprising repairing the memory device on-the fly and while the memory device is in a normal mode of operation.

15. A system for on-the-fly repair of a memory device, the system comprising:
memory configured to store one or more program modules; and
one or more processors coupled to the memory and configured to execute the one or more program modules to perform:
using one or more spare memory blocks to replace corresponding one or more memory blocks each including at least one non-operational memory cell;
storing memory repair information in a plurality of registers coupled in a chain;
identifying, upon a power-up test of the memory device, one or more non-operational memory cells, which are incremental to previously identified defective memory cells in previous power-up tests of the memory device;
providing corresponding memory repair information of the identified one or more non-operational memory cells;
blocking access to one or more registers of the plurality of registers;
facilitating storing, in one or more unblocked registers of the plurality of registers, the corresponding memory repair information of the identified one or more non-operational memory cells; and
swapping a memory block including the identified one or more non-operational memory cells with a spare memory block of the one or more spare memory blocks based on content of the one or more unblocked registers of the plurality of registers.

16. The system of claim 15, wherein the one or more processors are configured to execute the one or more program modules to use at least one of a spare memory row or a spare memory column to replace the corresponding one or more memory blocks each including the at least one non-operational memory cells.

17. The system of claim 15, wherein the one or more processors are configured to execute the one or more program modules to store the memory repair information in already existing BISR registers.

18. The system of claim 15, wherein each register of the plurality of registers is associated with a memory block, and wherein the content of the one or more unblocked registers of the plurality of registers comprise addresses of spare memory blocks available for incremental repair.

19. The system of claim 15, wherein the one or more processors are configured to execute the one or more program modules to provide address information corresponding to the non-operational memory cells.

20. The system of claim 15, wherein the one or more processors are configured to execute the one or more program modules to block access to the one or more registers of the plurality of registers if content of one or more registers of the plurality of registers is non-zero, indicating that a corresponding spare block of an associated memory block is unavailable.
